(19) United States
(12) Patent Application Publication
(10) Pub. No.: US 2003/0142712 A1
(43) Pub. Date: Jul. 31, 2003

(54) Small-sized light source of laser diode modules

(75) Inventors: Masami Ikeda, Tokyo (JP); Kenichi Namba, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: The Furukawa Electric Co., Ltd., Tokyo (JP)

(21) Appl. No.: 10/095,964

(22) Filed: Mar. 13, 2002

(30) Foreign Application Priority Data
Jan. 28, 2002 (JP) 2002-018460

(51) Int. Cl. H01S 3/04

(52) U.S. Cl. 372/36

(57) ABSTRACT

A small-sized light source of laser diode modules includes a plurality of coolerless laser diode modules without built-in Peltier devices arranged in a dense cluster, where each module includes a laser diode chip, optical components, a metal substrate with the laser diode chip and the optical components mounted thereon. It further includes a plurality of laser diode modules with a built-in cooler, where each module includes a laser diode chip, optical components, a metal substrate with the laser diode chip and the optical components mounted thereon, and a Peltier device thermally connected to the metal substrate.

### BACKGROUND OF THE INVENTION

1. Field of the Invention

The present invention relates to a small-sized light source of a plurality of high power laser diode modules, particularly with the laser diode modules arranged in high density.

2. Description of the Related Art

A laser diode module is usually used as a signal light source or a pump light source in optical fiber systems, particularly in the trunk line network and CATV. In order to realize high power output and steady operation, such a laser diode module has a built-in Peltier device, and there are disposed optical parts such as a laser diode chip, a photo diode chip, a lens, etc., and electrical parts such as a thermistor, an inductor, a resistor, etc. on a metal substrate mounted on the upper side of the Peltier device (hereinafter referred to as the “laser diode module with a built-in cooler”).

The Peltier device mentioned above is a thermoelectric semiconductor. If the semiconductor is a p-type, then heat is carried in the same direction as the electrical current, and if it is an n-type, then heat is carried in the direction opposite to that of the electrical current, thereby producing a temperature difference between the two ends thereof. A cooling system which incorporates the Peltier device thereinto utilizes this temperature difference in such a way that the low temperature side is used for cooling and the high temperature side is used for heat dissipation.

The laser diode module has a thermistor disposed in close proximity to the above-mentioned laser diode chip, which monitors temperature of the chip. Results of the temperature monitoring are then fed back in such a manner that the Peltier device is operated to cool the whole metal substrate on which the laser diode chip is disposed, thereby keeping the temperature of the laser diode chip constant.

A conventional laser diode module (i.e., a laser diode module with a built-in cooler) is illustrated in FIG. 12, a schematic illustration in cross-section. As shown in FIG. 12, the laser diode module comprises a mount 113 mounted with a laser diode chip 111 and a heat sink 112, a chip carrier 115 mounted with a photodiode chip 114 for monitoring, a lens holder 116, a metal substrate 110a on which resistors, inductors, circuit boards, etc., not shown in the figure, are disposed, and a Peltier device 117. The Peltier device is disposed on a heat dissipating plate 118 for a package and fixed thereto by means of metal solder. Ceramic boards 119A and 119B are disposed on top of and beneath the Peltier device 117, respectively.

FIG. 13 is a cross-sectional view taken along a line segment A-A′ in FIG. 12. As shown in FIG. 13, an essential part of the laser diode module includes the laser diode chip 111 and the thermistor 121, both of which are mounted on the heat sink 112, and a soft solder 122 holds the Peltier device 117 and the metal substrate 110a together so that a difference in the coefficient of thermal expansion of the two is appropriately relieved.

Usually, the above-mentioned metal substrate is formed of a single material such as cuprotungstite (CuW: one with 10 to 30 weight % of Cu is available). It has been a usual practice to use low-temperature soft solder, such as indium tin (InSn), to put a metal substrate and a Peltier device together so that a difference in the coefficient of thermal expansion of the two is appropriately relieved.

In recent years, however, as laser diode modules output more and more power than before, demands for better cooling capacity of the laser diodes as well as the thermo-environmental reliability (i.e., an ability to maintain normal operation when temperature changes) thereof are vehemently surging.

In order to improve cooling capabilities of laser diode modules, it would be necessary that the Peltier device be larger in size and/or a metal substrate which is disposed on the Peltier device be made of a material of better heat transfer. However, if the cooling capabilities of the Peltier device are improved and the temperature-adjustment time (a time needed to reach a target temperature) is shortened, then the thermal stress on the metal substrate mounted on the Peltier device increases. As a result, the difference in the coefficient of thermal expansion between the Peltier device and the metal substrate increases, affecting the mechanical integrity of the structure, and the soft solder holding the two together may fail by cracking and separation due to the lateral movement induced thereby. Furthermore, the solder creep phenomenon which is unique to soft solder becomes significant.

As described above, if the laser diode module outputs more power and the Peltier device becomes larger in size, then it would become difficult to densely arrange the laser diode modules. Furthermore, if a number of high-power laser diode modules are arranged in a dense cluster and used, then heat generated because of the increased output of the laser diode modules and the densely clustered arrangement thereof cannot properly be disposed of by simply enhancing heat transfer of the metal substrate disposed between the chip and the Peltier device or relieving the difference in the coefficient of thermal expansion, thereby preventing the laser diode modules from functioning normally.

In other words, each laser diode module is small in size and produces large amount of heat, and if it is used as pump light sources or signal light sources, where a plurality of laser diode modules need to be mounted, it would be difficult to dissipate heat properly. On the other hand, there is a constant demand that the pump light sources or signal light sources is designed to output more power. However, the cooling capacity of a conventional laser diode module using a Peltier device has come to a point where no further improvement in the cooling capacity of the Peltier device can be expected, and the semiconductor device cannot be utilized up to their maximum capacity.

Furthermore, the needs of the market is that power consumption of laser diode modules due to excitation and/or Peltier devices must not increase even though the optical output increases, and this needs makes the heat dissipation characteristics within the light source extremely important.

Furthermore, in addition to the laser diode modules, other heat generating devices for controlling the laser diode (for example, CPU) need to be taken under consideration when coping with heat generated by the laser diode module control substrate mounted therewith.

As described above, there is expected to realize light sources, for example Raman pump source, having excellent heat dissipation characteristics and being capable of including a large number of laser diode modules in a limited space, which can obtain an optically broadband and flat Raman gain.

### SUMMARY OF THE INVENTION

One embodiment of the present invention is a small-sized light source of laser diode modules comprising: a plurality of coolerless laser diode modules without built-in Peltier devices arranged in a dense cluster; a heat spreader thermally connected to each of said plurality of coolerless laser diode modules; a thermoelectric element thermally connected to said heat spreader; and a heat sink thermally connected to said thermoelectric element.

### BRIEF DESCRIPTION OF THE DRAWINGS

FIG. 1 is a schematic perspective view illustrating one embodiment of a small-sized light source of laser diode modules according to the present invention.

FIG. 2 is an exploded view illustrating essential parts of the small-sized light source of laser diode modules according to the present invention illustrated in FIG. 1.

FIG. 3 is a cross-sectional view illustrating a laser diode module with a built-in cooler according to the present invention.

FIG. 4 is a cross-sectional view illustrating a coolerless laser diode modules according to the present invention.

FIG. 5 is a diagram explaining in detail a group of coolerless laser diode modules according to the present invention.

FIG. 6 is a diagram illustrating the flow of heat within the small-sized light source of laser diode modules illustrated in FIG. 5.

FIG. 7 is a diagram explaining a heat sink used in the present invention.

FIG. 8 is a graph illustrating for comparison Raman gains of a light source of the present invention and a conventional light source.

FIG. 9 is a schematic perspective view illustrating another embodiment of a small-sized light source of laser diode modules according to the present invention.

FIG. 10 is a diagram illustrating an example of the disposition of parts between a motherboard and a daughter board.

FIG. 11 shows Table 1 listing excitation center wavelengths and corresponding excitation light power.

FIG. 12 is a schematic cross-sectional view illustrating a conventional laser diode module.

FIG. 13 is a cross-sectional view taken along a line segment A-A′ of the laser diode module of FIG. 12.

### DETAILED DESCRIPTION OF THE INVENTION

An embodiment of a small-sized light source of laser diode modules according to the present invention will be described in detail with reference to figures. One objective of the present invention is to provide a small-sized light source, for example a Raman pump module, of a plurality of high-power laser diode modules arranged in a dense cluster. The inventors of the present invention devoted considerable efforts toward resolving problems associated with conventional technologies described above. As a result, the inventor developed a technology of arranging a plurality of laser diode modules for excitation light source in a dense cluster within a small space, where small-sized coolerless diode modules are used for producing light which requires less excitation light power (for example, light corresponding to the wavelength of 1437.9 to 1487.8 nm) and conventional laser diode modules with a built-in cooler are used for producing light which requires much excitation light power. Moreover, it was found that the heat dissipation characteristics of coolerless diode modules can be improved by cooling the laser diode modules together as a whole which are arranged in a dense cluster by putting together a metal substrate on which a laser diode chip and optical components are mounted and a heat spreader in direct thermal contact, putting together the heat spreader and a thermoelectric element which functions as a so-called heat pump in thermal contact, and putting together the thermoelectric element and a heat sink in thermal contact.

Furthermore, it was found that the heat dissipation characteristics of the heat sink can considerably be improved by using a crimped fin-type heat sink which has a small fin pitch and, consequently, a large number of fins. Such a heat sink is obtained by providing a metal base plate, forming a plurality of grooves on the surface of the base plate, inserting heat dissipating fins into the grooves, and mechanically crimping and fixing the both sides of the dissipation fin.

It was found that a pump light source having excellent heat dissipation characteristics and being capable of loading a large number of laser diodes in a limited space, which can obtain an optically broadband and flat Raman gain can be obtained by using the above-mentioned crimped fin-type heat sink, using a group of the above-mentioned coolerless laser diode modules, the whole group being put together with the heat sink in thermal contact, and using a group of the laser diode modules with a built-in cooler, the Peltier device of each laser diode module being put together with the above-mentioned heat sink in thermal contact.

Furthermore, it was found that, when loading a plurality of laser diode modules, a location of each module as well as the orientation thereof can freely be chosen, thereby increasing the degree of freedom in designing. The present invention was made based on the above research results.

A small-sized light source of laser diode modules according to the present invention comprises: a plurality of coolerless laser diode modules without built-in Peltier devices arranged in a dense cluster; a heat spreader thermally connected to each of said plurality of coolerless laser diode modules; a thermoelectric element thermally connected to said heat spreader; and a heat sink thermally connected to said thermoelectric element.

Furthermore, a small-sized light source of laser diode modules according to the present invention comprises: a group of a plurality of coolerless laser diode modules without built-in Peltier devices arranged in a dense cluster, each of said coolerless laser diode module without built-in Peltier device including a laser diode chip, optical components and a metal substrate with said laser diode chip and optical components mounted thereon; and a group of a plurality of laser diode modules with a built-in cooler, each of said laser diode module with a built-in cooler including a laser diode chip, optical components, a metal substrate with said laser diode chip and said optical components mounted thereon, and a Peltier device thermally connected to said metal substrate.

Furthermore, a small-sized light source of laser diode modules according to the present invention comprises: a first board with said group of a plurality of coolerless laser diode modules mounted thereon; and a second board with said group of a plurality of laser diode modules with a built-in cooler mounted thereon; wherein: said first board and said second board are mounted on said heat sink; said metal substrate of each module of said group of a plurality of coolerless laser diode modules is thermally connected to said heat sink via said heat spreader and said thermoelectric element; and said Peltier device of each module of said group of a plurality of laser diode modules with a built-in cooler is thermally connected to said heat sink.

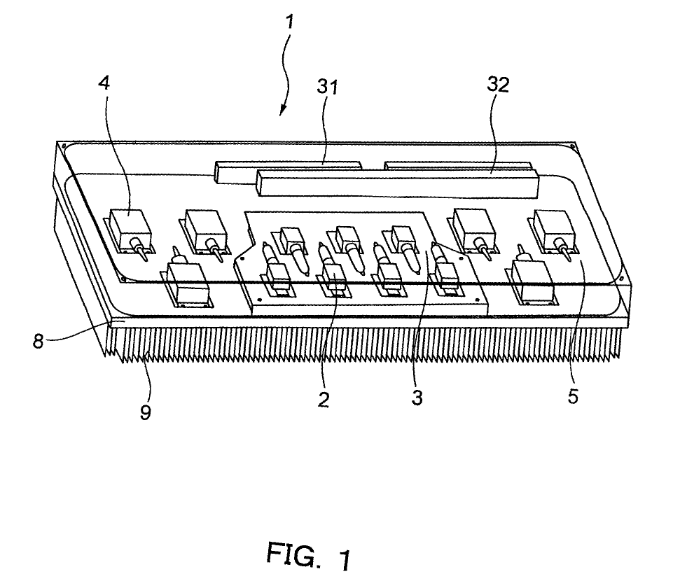

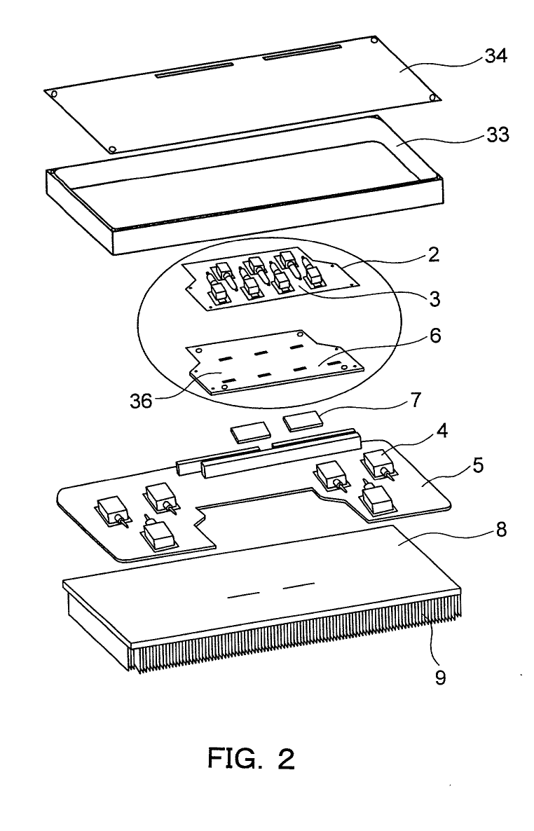

FIG. 1 is a schematic perspective view illustrating one embodiment of a small-sized light source of laser diode modules according to the present invention. FIG. 2 is an exploded view illustrating an essential part of the small-sized light source of laser diode modules according to the present invention illustrated in FIG. 1.

In the small-sized light source of laser diode modules according to the present invention shown in FIG. 1, a group of coolerless laser diode modules comprising seven of such modules 2 arranged in predetermined relative positioning are mounted on a first board 3, and six of laser diode modules with a built-in cooler 4 are disposed in predetermined arrangement and mounted on a second board 5 in such manner as surrounding the first board 3 in a C-shape configuration, three of such modules being mounted on one side of the second board and the remaining three on the other side. Disposed underneath of the first board 3 and the second board 5 is a crimped fin-type heat sink comprising a base plate 8 and heat dissipating fins 9 crimped thereon.

As described above, in the embodiment illustrated in FIG. 1, a group of coolerless laser diode modules and a group of laser diode modules with a built-in cooler are combined. As will be described later, heat generated by the group of coolerless laser diode modules flows through the metal substrate, the heat spreader and the thermoelectric element and reaches the heat sink, and heat generated by the group of laser diode modules with a built-in cooler flows through the Peltier devices and reaches the heat sink, where the heat dissipates from the heat dissipating fins to a predetermined direction.

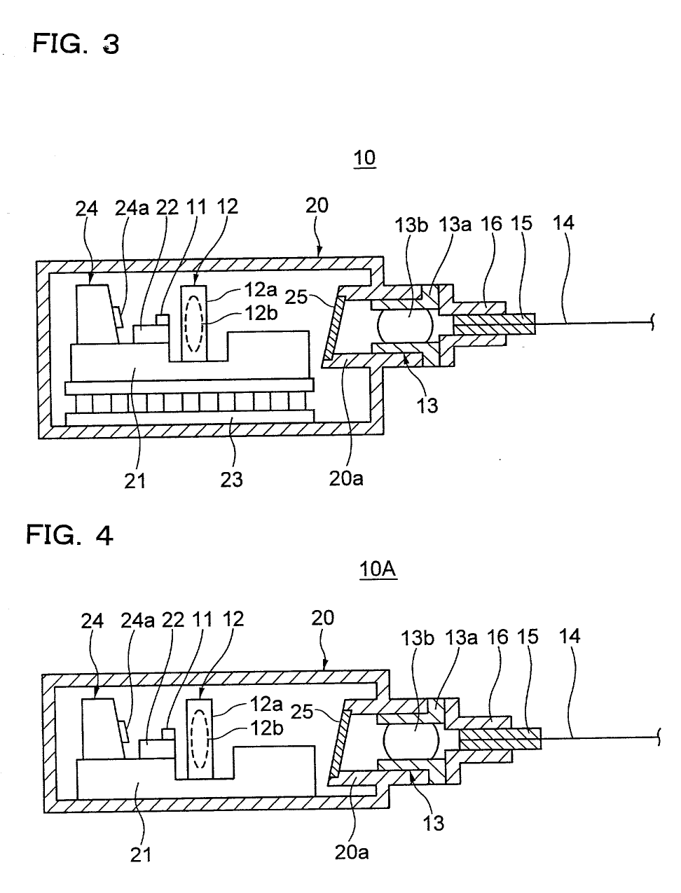

FIG. 3 is a schematic sectional view illustrating a laser diode module with a built-in cooler according to the present invention. As illustrated in FIG. 3, the laser diode module 10 includes a laser diode chip 11, a first lens 12, a second lens 13, a core enlarged fiber 14, and an hermetically sealed casing 20. The laser diode chip 11 is held by a chip carrier 22 provided on a metal substrate 21, the chip 11 being across the first lens 12 with a predetermined distance. The metal substrate 21 is disposed above the Peltier device 23 for temperature control provided inside the hermetically sealed casing 20. The metal substrate 21 is made of a composite material, where the essential part thereof is made of copper and a portion where the first lens 12 is disposed is made of stainless steel. Provided on the metal substrate 21 is a carrier 24 fixed on the side opposing to the first lens 12 with the chip carrier 22 being interposed therebetween, and a photo diode 24a for monitoring is provided on the carrier 24 at the position opposing to the laser diode chip 11 on the chip carrier 22.

The first lens 12 is made of a lens holder 12a and a collimating lens 12b held thereby. The lens holder 12a is fixed on the metal substrate 21 by welding. The collimating lens 12b is aspheric in order to obtain high coupling efficiency. The second lens 13 comprises a lens holder 13a and a spherical lens 13b held thereby, the top and bottom portions thereof being ground off. The lens holder 13a is fixed in an insertion cylinder 20a to be described later of the hermetically sealed casing 20 in such manner that the position adjustment thereof is performed within a surface perpendicular to the optical axis.

The tip of the core enlarged fiber 14, where the core has been enlarged, is diagonally ground along a surface tilted by 6° with respect to the optical axis. The ground surface is treated with antireflection coating, and the tip is inserted into a metal cylinder 15 and glued there for protection. The metal cylinder 15 is fixed to an adjustment member 16 at the most appropriate position by welding. The position of the metal cylinder 15 in the adjustment member 16 is adjusted by sliding the cylinder 15 therein back and forth along the optical axis of the core enlarged fiber 14 and/or by revolving around the optical axis therein.

FIG. 4 is a diagram illustrating a coolerless laser diode module according to the present invention. As illustrated in FIG. 4, this coolerless laser diode module of the present invention does not have a built-in Peltier device shown as in FIG. 3. Besides that, it is generally the same as the laser diode module shown in FIG. 3. More specifically, the bottom surface of the metal substrate 21 with the laser diode chip 11 and optical component 12 mounted makes direct contact with the hermetically sealed casing 20. Therefore, the coolerless laser diode module of the present invention illustrated in FIG. 4 is considerably more compact than the laser diode module with a built-in cooler and can be arranged in a dense cluster.

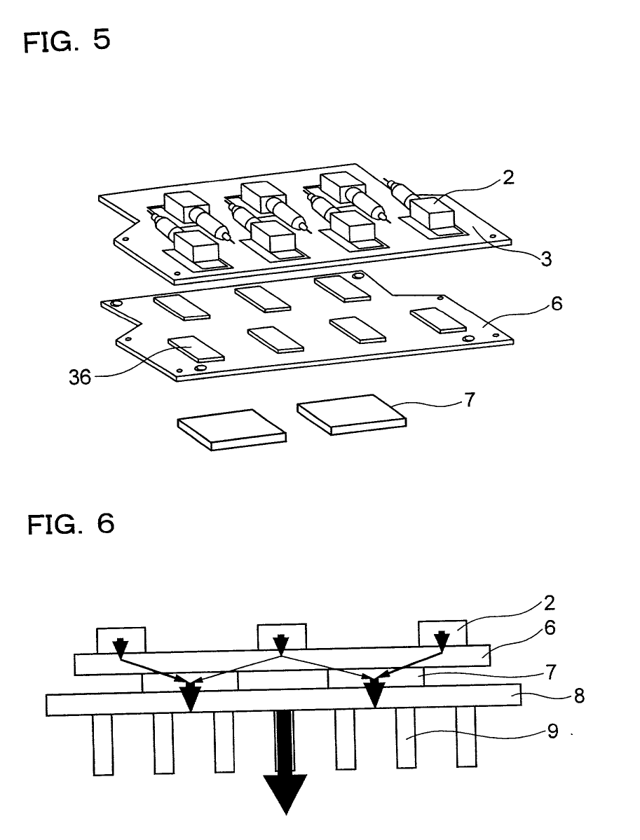

FIG. 5 is a diagram explaining in detail a group of coolerless laser diode modules according to the present invention. As illustrated in FIG. 5, a small-sized light source of laser diode modules according to the present invention comprises: a plurality of coolerless laser diode modules 2 without built-in Peltier devices arranged in a dense cluster, each module comprising a metal substrate with a laser diode chip and optical components mounted thereon, a heat spreader 6 making direct thermal connection to the coolerless laser diode modules 2, a thermoelectric element 7 thermally connected to the heat spreader 6, and a heat sink (not shown in the figure) making contact with the thermoelectric element 7. More specifically, the metal substrate of the coolerless laser diode module 2 with the laser diode chip and the optical components mounted thereon makes thermal contact with the heat spreader 6 (for example, the metal substrate makes thermal contact with a convex part 36 provided so as to correspond to the coolerless laser diode module 2 as illustrated in FIG. 5), and the heat spreader 6 further makes thermal contact with the thermoelectric element such as Peltier devices.

FIG. 6 is a diagram illustrating the flow of heat within the small-sized light source of laser diode modules illustrated in FIG. 5. As illustrated in FIG. 6, heat flows from the metal substrate of the coolerless laser diode module 2 with the laser diode chip and the optical components mounted thereon to the heat spreader 6. The heat spreader is made of a material having excellent coefficient of thermal conductivity or of heat pipes, thereby diffusing heat from the plurality of coolerless laser diode modules 2 instantly to a large area. The bottom surface of the heat spreader 6 makes thermal contact with the thermoelectric element 7, and the thermoelectric element 7 further makes thermal contact with the crimped fin-type heat sink, which is made of the base plate 8 and the heat dissipating fins 9 crimped to the base plate. The thermoelectric element 7 functions as a so-called heat pump and instantly transfers heat flowing into the heat spreader 6 to the crimped fin-type heat sink, which has excellent heat dissipation characteristics because of the reduced fin pitch and a large number of heat dissipating fins. Heat is then dissipated to a predetermined location.

The small-sized light source of laser diode modules according to the present invention, whose embodiment is illustrated in FIG. 1, will be described in detail with reference to FIG. 2. As illustrated in the circle in FIG. 2, a group of coolerless laser diode modules are mounted on the first board, where the coolerless laser diode modules 2 without built-in Peltier devices, each comprising a metal substrate with a laser diode chip and optical components mounted thereon, are arranged in predetermined relative positions. Disposed in thermal contact below the coolerless laser diode modules 2 are the heat spreader 6, the thermoelectric elements 7, and the crimped fin-type heat sink made of the base plate 8 and the heat dissipating fins 9 crimped to the base plate. In the above structure, As described above, the metal substrate makes thermal contact with the convex parts 36 which are provided so as to correspond to the coolerless laser diode modules 2.

A plurality of laser diode modules with a built-in cooler 4 are mounted on both side portions of the second board 5 in such manner as surrounding the above-mentioned first board 3 in a C-shape configuration. Disposed under the second board 5 is the crimped fin-type heat sink made of the base plate 8 and heat dissipating fins 9 crimped to the base plate. The Peltier devices of the laser diode modules with a built-in cooler 4 make thermal contact with the crimped fin-type heat sink. Disposed on the base plate of the heat sink on which the coolerless laser diode modules and the laser diode modules with a built-in cooler are thus mounted are a casing 33 and a casing lid 34.

The above-described laser diode modules with a built-in cooler are attached to the heat sink made of, for example, aluminum with thermal interface material such as thermal grease applied therebetween so that heat from the laser diode modules with a built-in cooler is efficiently dissipated. Electric terminals of the laser diode modules with a built-in cooler are soldered to an electrical substrate (the second board) attached to the heat sink.

In the coolerless laser (which may be called as a mini laser) diode module, the heat spreader made of a material having excellent heat transfer such as copper and aluminum is attached to the heat sink with the thermal interface material applied therebetween. The heat spreader may comprises a heat pipe made of copper or aluminum. Disposed on the surface of the heat spreader opposite to where the coolerless laser diode modules are disposed are the thermoelectric elements for cooling such as Peltier devices with thermal interface material applied therebetween. The above-explained unit comprising the coolerless laser diode modules, the heat spreader and the thermoelectric elements is called as a mini laser unit. The mini laser unit is thus fabricated. The mini laser unit is attached to the heat sink with thermal interface material applied therebetween.

As described above, since the heat spreader is generally made of a material having high coefficient of thermal conductivity, heat can efficiently be transferred, thereby resulting in less temperature difference across the heat spreader. By using this principle, heat generated by each coolerless laser diode module can efficiently be transferred to thermoelectric elements (for example, Peltier devices) through the heat spreader.

Furthermore, electrical terminals of the mini laser diode module are soldered to the electric substrate (the first board) attached to the heat spreader. The first board is electrically connected to the second board through connectors. Power supply to the mini laser diode module is routed through the second board by the connector attached to the second board.

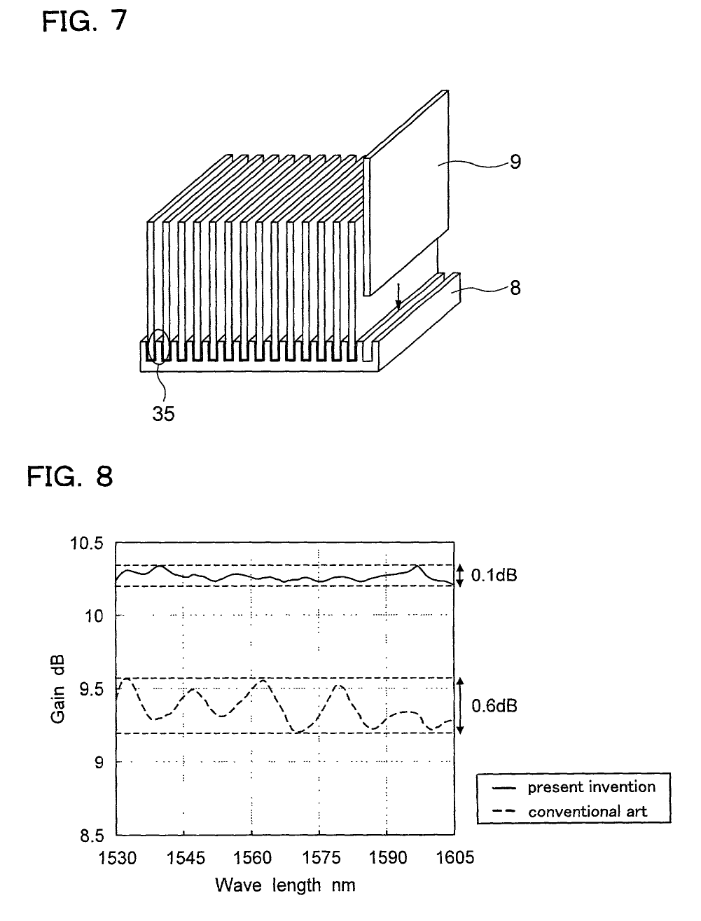

Next, a heat sink according to the present invention will be described. FIG. 7 is a perspective view illustrating a heat sink used in the present invention. As illustrated in FIG. 7, this is a crimped fin-type heat sink comprising a base plate 8 and heat dissipating fins 9 crimped to the base plate. More specifically, a plurality of grooves are formed on one side of the base plate 8 of the heat sink at a specified pitch (for example, 2 mm pitch). Then, heat dissipating fins are fixed and thermally connected to the base plate by inserting fin plates (for example, having thickness of 0.4 mm) to the above-mentioned grooves and then crimping a portion of the base plate between grooves (designated by reference numeral 35 in the figure). Although it was impossible for conventional machined fins to have a fin pitch of less than 5 or 6 mm and for a conventional extruded heat sink a fin pitch of less than 10 mm, the heat sink of the present invention which are formed as described above can have a fin pitch of 2 mm, which makes it possible to arrange the heat dissipating fins much closer to one another (in other words, densely arranged), thereby obtaining a heat sink having excellent thermal characteristics.

Incidentally, two different kinds of metal (for example, copper and aluminum) can be used to make the heat dissipating fins. By using metal having high heat transfer (copper) for a portion of the heat dissipating fins corresponding to laser diode modules and other metal (aluminum) for other portions, a heat sink of further excellent thermal performance can be obtained.

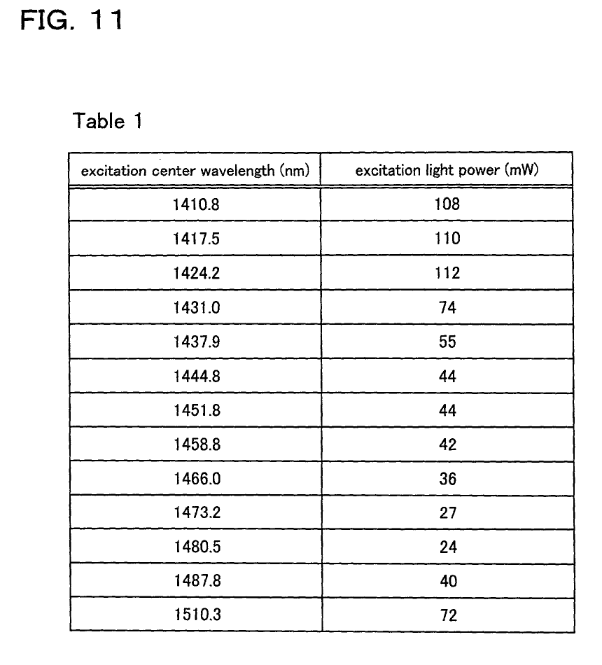

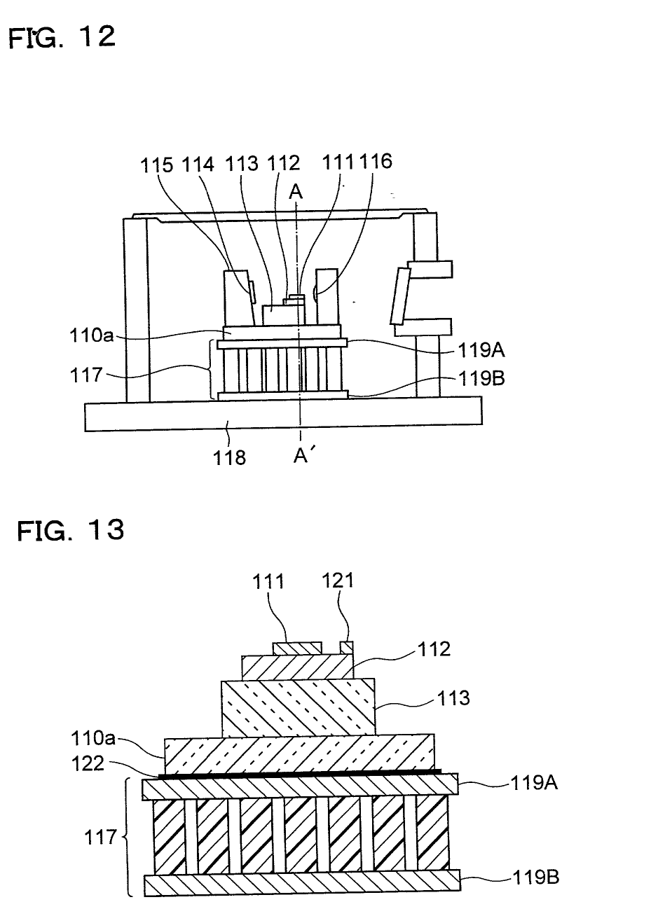

Optical characteristics of a small-sized light source of laser diode modules according to the present invention are such that a 10 dB gain can be obtained with SMF (Single Mode Fiber) for bandwidths of 1530 nm to 1605 nm (C and L bands) and require excitation for thirteen wavelengths. Table 1 in FIG. 11 shows the excitation center wavelengths and the excitation power. From the table, those which have wavelengths of 1444.8 nm to 1487.8 nm and require less excitation power are covered by the coolerless laser diode modules, and those which have wavelengths other than the above are covered by the regular laser diode modules with a built-in cooler.

Incidentally, in a case where a pump light source for the fibre amplification that is capable of obtaining a high gain with relatively low excitation power, is to be obtained, the light source can be formed by using only the above-mentioned mini laser unit as the coolerless laser diode modules.

Furthermore, a flexible substrate can be used for the electrical connection between the first board (i.e., daughter board) and the second board (i.e., motherboard).

In the case of a light source using conventional laser diode modules with a built-in cooler, if a module has a footprint of 270 mm×150 mm, then only six of the laser diode modules with a built-in cooler can be mounted thereon, and if a module has a footprint of 300 mm×200 mm, then only eight of the laser diode modules with a built-in cooler can be mounted thereon. In FIG. 8, the Raman gain of a conventional light source is shown by a dashed line. On the other hand, in the case of the small-sized light source of laser diode modules according to the present invention, thirteen laser diode modules are mounted on a module having a footprint of 215 mm×120 mm. The Raman gain of the light source according to the present invention is shown in FIG. 8 by a solid line.

As can be seen from FIG. 8, a constant gain cannot be obtained over a broad band with the use of the conventional light source, and the gain flatness is as poor as 0.6 dB. On the other hand, a constant gain can be obtained over a broad band with the use of the light source according to the present invention, and the gain flatness is as good as 0.1 dB.

FIG. 10 is a diagram illustrating an example where the parts are disposed in the space between the motherboard and the daughter board. As illustrated in FIG. 10, it is possible to dispose optical components or devices for driving and/or controlling laser diode modules within the space between the motherboard (the second board) and the daughter board (the first board).

A light source of laser diode modules according to the present invention is used for a pump light source in the optical fiber systems. Furthermore, a light source of laser diode modules according to the present invention is used for a signal light source in the optical fiber systems.

Furthermore, a Raman amplifier according to the present invention is a Raman amplifier using a light source of laser diode modules according to the present invention.

### EXAMPLES

A small-sized light source of laser diode modules according to the present invention will be described by examples.

### Example 1

As illustrated in FIG. 1, the first board and the second board were disposed on a module having a footprint of 215 mm×120 mm in such a way that the second board surrounded the first board in a C-shaped configuration. Seven coolerless laser diode modules were then mounted on the first board, and three laser diode modules with a built-in cooler were mounted on one side portion of the second board and other three on the other side portion of the second board. The coolerless laser diode modules were thermally connected to the heat sink via the heat spreader and the Peltier devices, and the laser diode modules with a built-in cooler were thermally connected to the heat sink. Thermal interface material was applied between the above components.

A crimped fin-type heat sink comprising a base plate and heat dissipating fins crimped to the base plate was used as the heat sink. More specifically, a plurality of grooves were formed on one side of the base plate 8 of the heat sink at a certain pitch (for example, a 2 mm pitch). Fin plates (for example, having a thickness of 0.4 mm) were then inserted into the groove and a portion of the base plate between the grooves were crimped, thereby fixing and thermally connecting the fin plates to the base plate.

When the heat sink of the present invention described above was used with cooling air temperature of 40° C. and cooling air velocity of 1.0 m/s, heat generation of 76 W due to the laser diode modules with a built-in cooler and the group of coolerless laser diode modules (mini laser unit) were effectively cooled, thereby keeping the temperature of the casing for the laser diode modules with a built-in cooler as well as the temperature on the high temperature side of the Peltier devices of the group of coolerless laser diode modules (mini laser unit) below the designed temperature of 70° C.

### Example 2

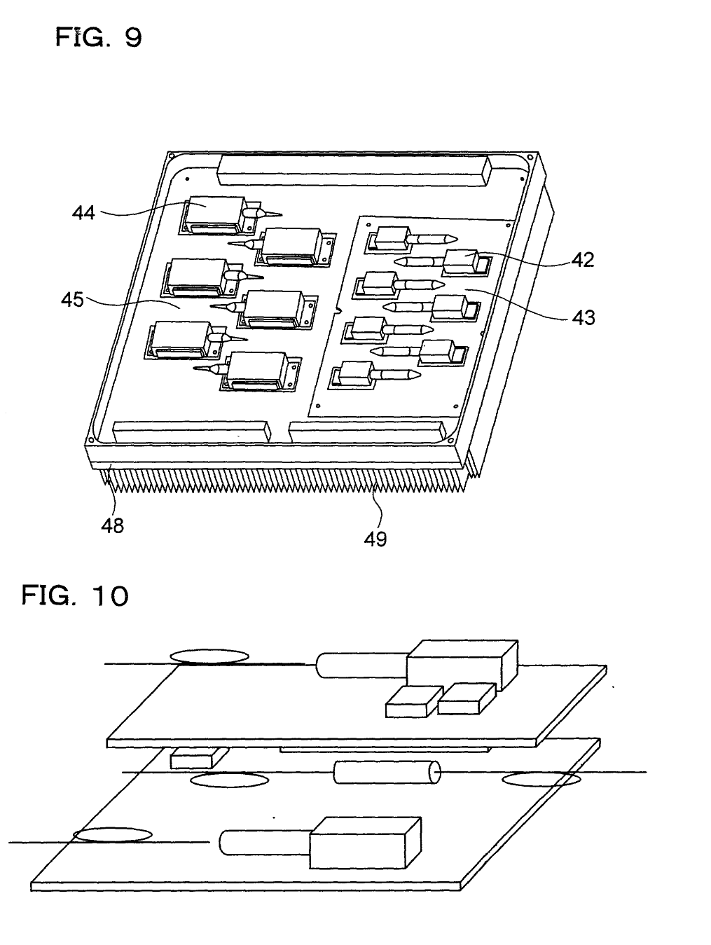

As shown in FIG. 9, seven coolerless laser diode modules were mounted on the first board, and six laser diode modules with a built-in cooler were mounted on the second board. The first board and the second board were then disposed side by side on a module having a footprint of 150 mm×160 mm. The coolerless laser diode modules were thermally connected to the heat sink via the heat spreader and the Peltier devices, and the laser diode modules with a built-in cooler were thermally connected to the heat sink. Thermal interface material was applied between the above components.

A crimped fin-type heat sink comprising a base plate and heat dissipating fins crimped to the base plate was used as the heat sink. More specifically, a plurality of grooves were formed on one side of the base plate of the heat sink at a certain pitch (for example, 2 mm pitch). Fin plates (for example, having a thickness of 0.4 mm) were then inserted into the groove and a portion of the base plate between the grooves were crimped, thereby fixing and thermally connecting the fin plates to the base plate.

When the heat sink of the present invention described above was used with cooling air temperature of 40° C. and cooling air velocity of 1.0 m/s, and heat generation of 76 W due to the laser diode modules with a built-in cooler and the group of coolerless laser diode modules were effectively cooled, thereby keeping the temperature of the casing for the laser diode modules with a built-in cooler and the temperature on the high temperature side of the Peltier devices of the group of coolerless laser diode modules below the design temperature of 70° C.

As described above, according to the present invention, limitations on environmental conditions for using a super small-sized excitation light source can be overcome. Furthermore, since a number of pump light sources can be mounted on a small space, a broad band super flat gain-type super small-sized excitation light source can be obtained. Furthermore, since heat dissipation characteristics are excellent and steady, thermal characteristics of the optical components can be controlled, thereby obtaining a super small-sized excitation light source having steady optical characteristics. Furthermore, a super small-sized excitation light source having steady optical characteristics can be obtained at low cost.

As described above, according to the present invention, a light source comprising a plurality of thin laser diode modules of high output disposed in a dense cluster with high degree of freedom can be obtained. A pump light source or a signal light source which is compact and capable of maintaining high output at no expense of consumption power can be obtained. The present invention is therefore industrially valuable.

As many apparently widely different embodiments of this invention may be made without departing from the spirit and scope thereof, it is to be understood that the invention is not limited to the specific embodiments thereof except as defined in the appended claims.

What is claimed is:

1. A small-sized light source of laser diode modules comprising:
a plurality of coolerless laser diode modules without built-in Peltier devices arranged in a dense cluster;
a heat spreader thermally connected to each of said plurality of coolerless laser diode modules;
a thermoelectric element thermally connected to said heat spreader; and
a heat sink thermally connected to said thermoelectric element.

2. A small-sized light source of laser diode modules as claimed in claim 1, wherein
said heat sink is a crimped fin-type heat sink comprising a base plate and heat dissipating fins fixed onto said base plate by crimping with small fin pitch of said heat dissipating fins.

3. A small-sized light source of laser diode modules as claimed in claim 2, wherein
said heat dissipating fins are made of two different kinds of metals.

4. A small-sized light source of laser diode modules as claimed in claim 1, wherein
a metal substrate of said coolerless laser diode module with a laser diode chip and optical components mounted thereon is thermally connected to said heat spreader.

5. A small-sized light source of laser diode modules, comprising:
a group of a plurality of coolerless laser diode modules without built-in Peltier devices arranged in a dense cluster, each of said coolerless laser diode module without built-in Peltier device including a laser diode chip, optical components and a metal substrate with said laser diode chip and optical components mounted thereon; and
a group of a plurality of laser diode modules with a built-in cooler, each of said laser diode module with a built-in cooler including a laser diode chip, optical components, a metal substrate with said laser diode chip and said optical components mounted thereon, and a Peltier device thermally connected to said metal substrate.

6. A small-sized light source of laser diode modules as claimed in claim 5, further comprising:
a heat spreader thermally connected to each module of said group of a plurality of coolerless laser diode modules;
a thermoelectric element thermally connected to said heat spreader; and
a heat sink thermally connected to said thermoelectric element as well as said group of a plurality of laser diode modules with a built-in cooler.

7. A small-sized light source of laser diode modules as claimed in claim 6, further comprising:
a first board with said group of a plurality of coolerless laser diode modules mounted thereon; and
a second board with said group of a plurality of laser diode modules with a built-in cooler mounted thereon; wherein:
said first board and said second board are mounted on said heat sink;
said metal substrate of each module of said group of a plurality of coolerless laser diode modules is thermally connected to said heat sink via said heat spreader and said thermoelectric element; and
said Peltier device of each module of said group of a plurality of laser diode modules with a built-in cooler is thermally connected to said heat sink.

8. A small-sized light source of laser diode modules as claimed in claim 7, wherein:
said heat sink is a crimped fin-type heat sink comprising a base plate and heat dissipating fins fixed onto said base plate by crimping with small fin pitch of said heat dissipating fins.

9. A small-sized light source of laser diode modules as claimed in claim 8, wherein
said heat dissipating fins are made of two different kinds of metals.

10. A small-sized light source of laser diode modules as claimed in claim 7, wherein:
said group of a plurality of coolerless laser diode modules comprises laser diode modules of different wavelengths.

11. A small-sized light source of laser diode modules as claimed in claim 10, further comprising:
a coupler for wavelength multiplexing of optical outputs from said group of a plurality of coolerless laser diode modules and said group of a plurality of laser diode modules with a built-in cooler; and
an excitation light multiplexer for multiplexing said wavelengths-multiplexed optical light.

12. A small-sized light source of laser diode modules as in any one of claims 1-4, 6-11, wherein:
said heat spreader is made of heat pipes.
